(19) United States
(12) Patent Application Publication
(10) Pub. No.: US 2010/0232985 A1
(43) Pub. Date: Sep. 16, 2010

(54) FUEL GAS CONDITIONING WITH MEMBRANE SEPARATION

(75) Inventors: John A. Jensvold, Benicia, CA (US); Steven B. Todaro, Houston, TX (US); Marc Straub, Brentwood, CA (US)

Correspondence Address: WILLIAM H. EILBERG, 316 CALIFORNIA AVE. #785, RENO, NV, 89509, US

(73) Assignee: GENERON IGS, INC., Houston, TX (US)

(21) Appl. No.: 12/711,019

(22) Filed: Feb. 23, 2010

Related U.S. Application Data
(60) Provisional application No. 61/158,816, filed on Mar. 10, 2009.

(51) Int. Cl. F04B 17/05; B01D 53/22

(52) U.S. Cl. 417/53; 417/364; 96/6

(57) ABSTRACT

Compressed natural gas is produced by a compressor, located near a natural gas well. The compressor being driven by a gas engine. A portion of the compressed natural gas is diverted, and passed through a dehydration membrane, and also through a gas-separation membrane which selects for carbon dioxide. The result is a natural gas stream which is relatively dry, and relatively free of carbon dioxide. This stream is used as fuel for the gas engine which drives the compressor. The permeate gases from the membrane may be recycled. The system enables the natural gas to be compressed efficiently, by providing a conditioned fuel gas for driving the compressor.

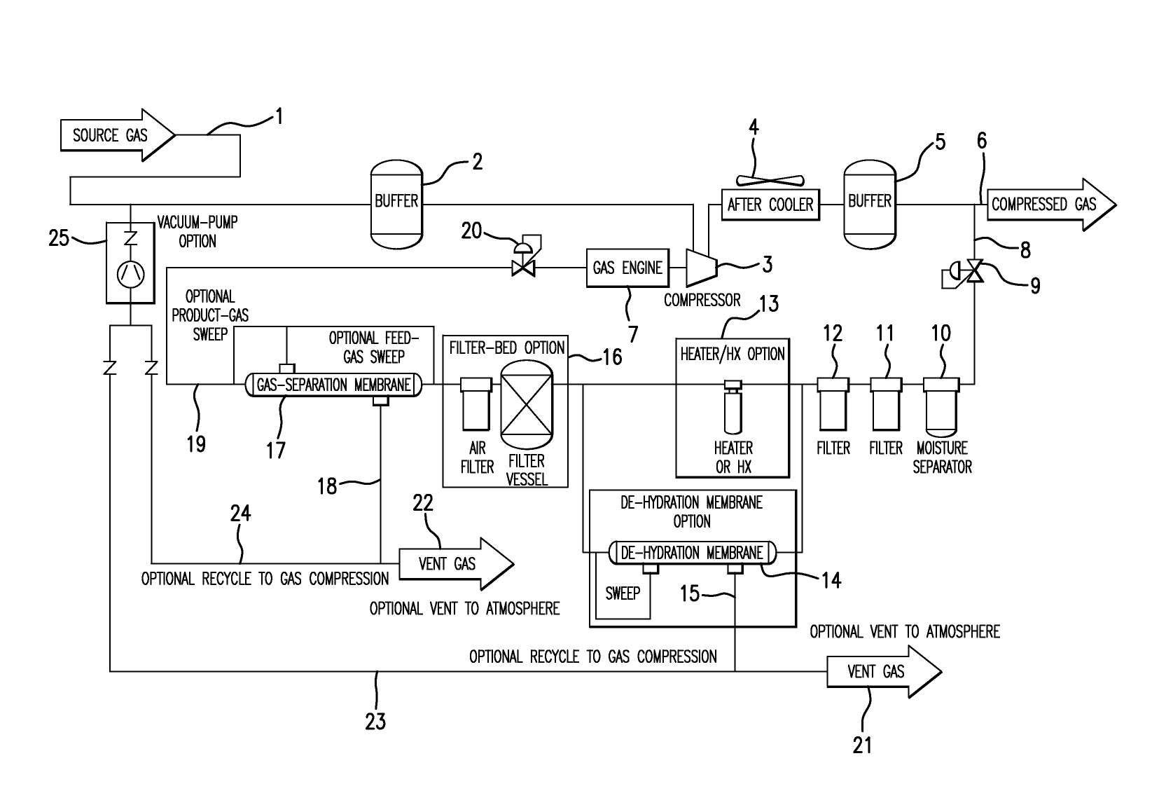

### CROSS-REFERENCE TO PRIOR APPLICATION

Priority is claimed from U.S. Provisional Patent Application Ser. No. 61/158,816, filed Mar.10, 2009, the disclosure of which is incorporated by reference herein.

### BACKGROUND OF THE INVENTION

This invention relates to the field of production of natural gas, and provides an improvement in the production process. More particularly, the invention provides a method and apparatus for conditioning of natural gas fuel, so that it can be used to fuel a gas engine which drives a compressor at the site of a well.

Natural gas, consisting primarily of methane, is used as a fuel for various engines, such as those used in power plants, in vehicles, and elsewhere.

As part of the process of producing natural gas, it is necessary to compress the gas which has been extracted from the well, for transportation and/or storage. Thus, it is necessary to provide a compressor at the site of the well. Because the well is typically located in a remote area, the most convenient way to operate the compressor is to use a gas engine which is fueled by the same gas being extracted from the well. Thus, a relatively small stream of natural gas is diverted from the main production stream, for the purpose of fueling the engine which drives the compressor.

The natural gas fuel is typically taken from the discharge side of the compressor, at pressures from about 100 psig up to about 1100 psig. The pressure is then reduced to about 100 psig, and the gas is filtered and its pressure reduced again to match the requirement for the inlet pressure of the fuel system of the engine.

Natural gas streams often include carbon dioxide. The carbon dioxide may be present naturally; some wells produce gas with relatively low CO₂ content, while others produce gas having higher CO₂ concentrations. Also, in some cases, CO₂ may be injected into the well as a drilling fluid, to aid in extraction, or it may be injected into the formation to assist in recovery of the natural gas. The result is that the recovered gas may have a greater CO₂ content than it would have naturally.

A high CO₂ content in natural gas presents several problems. If water is present, the CO₂ will react with the water to form carbonic acid, which is highly corrosive, and thus harmful to the engine and compressor. A high CO₂ content also reduces the effective specific heat of the mixture, making the gas less effective as fuel. If the gas engine, which drives the compressor, is operated with fuel containing CO₂, the performance of the engine will be less than optimal, and the engine may require increased maintenance.

Also, a high level of CO₂ in the fuel gas will also cause more CO₂ to be emitted in the exhaust gas of the engine. That is, the exhaust gas includes the combustion products plus the CO₂ in the fuel feed. The latter emission may exceed regulatory requirements for CO₂. A system which reduces the amount of CO₂ in the fuel gas has the advantage of making it easier to comply with such regulatory requirements.

The present invention provides a system and method which addresses the above problem, by providing fuel for a gas engine, for driving a compressor located at the site of a well, while avoiding damage to that engine.

### SUMMARY OF THE INVENTION

The present invention comprises a method and apparatus for conditioning natural gas fuel. The conditioned natural gas fuel is used for a gas engine which drives a compressor at or near a natural gas well.

According to the invention, a stream of natural gas is taken from the main stream, and its pressure is reduced as needed. The stream is passed through a moisture separator, to remove liquid water, and one or more filters, to remove particulates. The stream is then passed through a dehydration membrane module, so as to separate water vapor from the stream. The stream is next passed through a gas-separation membrane module, which removes carbon dioxide (and possibly hydrogen sulfide) from the stream. The conditioned stream is then used as fuel for the gas engine which drives the compressor.

The permeate streams from the membrane modules comprise waste gases. These streams may be vented to the atmosphere. To the extent that such venting is not desired or permitted, the permeate streams may be recycled into the main natural gas stream. Such recycling has the advantage of recovering unused natural gas which may have remained in the stream. It is understood that carbon dioxide must eventually be removed from the main natural gas product stream, but such removal is typically performed at a different site from the production well.

The present invention therefore has the primary object of providing a method and apparatus for conditioning a stream of natural gas.

The invention has the further object of improving the process of natural gas production, by providing a conditioned fuel for a gas engine used to drive a compressor at a wellhead.

The invention has the further object of reducing the cost of operation and maintenance, and improving the efficiency, of a gas engine used to drive a compressor at a wellhead.

The invention has the further object of providing a method and apparatus for producing a stream of natural gas which is substantially free of carbon dioxide.

The reader skilled in the art will recognize other objects and advantages of the invention, from a reading of the following brief description of the drawing, the detailed description of the invention, and the appended claims.

### BRIEF DESCRIPTION OF THE DRAWING

The FIGURE provides a schematic diagram of the system of the present invention.

### DETAILED DESCRIPTION OF THE INVENTION

Natural gas is extracted from a well (not shown) and enters the system through conduit 1. Most of the natural gas is simply compressed and conveyed out of the system. More particularly, the gas flows in a path which includes buffer 2, compressor 3, after-cooler 4, and buffer 5. The product gas leaves the system through conduit 6. Thus, the components described above include means for extracting the natural gas from a source, and for conveying the compressed natural gas towards a point of use.

The buffers may simply be tanks which allow gas to accumulate, and to be withdrawn, so as to accommodate swings in pressure in the line.

The compressor 3 is driven by gas engine 7. Engine 7 is fueled by natural gas which is taken from the main gas stream. Specifically, gas is diverted, from conduit 6, into conduit 8, through controllable valve 9. Valve 9 may be a pressure regulating valve; in general, it is necessary to reduce the pressure of the gas stream before it can be directed into a membrane system, and before it can be used to fuel the gas engine. As will be described below, the gas is treated so as to remove carbon dioxide, before being conveyed into the engine 7.

The treatment of the gas entering through conduit 8 is as follows. The gas passes through moisture separator 10, which removes liquid water from the stream. It is necessary to remove liquid water before passing the gas through a polymeric membrane, because water would degrade the membrane.

The gas then passes through filters 11 and 12, which remove particulates from the stream.

The gas could then optionally pass through heater 13, which would tend to prevent water vapor from condensing in the feed stream prior to the membrane module. A better option is to pass the gas through dehydration membrane module 14. The dehydration membrane is preferred to the option of using the heater. The dehydration membrane module includes a membrane made of a polymeric material which separates water vapor from other components of a gas stream. Such polymeric materials are known in the art. An example of a dehydration membrane is described in U.S. Pat. No. 7,294,174, the disclosure of which is incorporated by reference herein.

In the embodiment shown, the water vapor comprises the permeate gas, and the permeate is removed from the membrane module through conduit 15. The dehydration membrane may use the non-permeate gas as a sweep gas, as shown in the Figure.

The output of the dehydration membrane (or of the heater 13, if that option is used) is then passed through filter system 16. The filter system may include a filter bed, and an air filter, or both, for removal of more particulate material which may remain in the stream.

The gas is then directed into gas-separation membrane module 17. The module 17 includes a polymeric membrane which is chosen to select between natural gas (primarily methane) and carbon dioxide. The membrane may also select for hydrogen sulfide. The carbon dioxide and/or hydrogen sulfide comprise the permeate gas in module 17, and are removed through a permeate vent, and conveyed in conduit 18. As is the case for the dehydration membrane module, the non-permeate gas in module 17 may be used as a sweep gas, as shown.

The output of module 17, which appears at conduit 19, comprises natural gas (primarily methane) which contains little or no water, and little or no carbon dioxide. This stream passes through controllable valve 20, and into gas engine 7. The valve 20 may be a pressure regulating valve; it may be necessary, in general, to adjust the pressure of the stream again to match the pressure requirement of the inlet of the fuel system of the engine.

The permeate gases from modules 14 and 17 may be vented to the atmosphere, as indicated by arrows 21 and 22, respectively. More preferably, these permeate gases are recycled to the compressor by passing them through conduits 23 and 24, with the aid of vacuum pump 25. The vacuum pump provides a pressure differential in both membranes, and thereby assures that the gases will flow as desired. The recycling described above has the advantage that one recovers residual methane which may exist in the permeate streams, but has the disadvantage that it injects unwanted gases (water vapor and carbon dioxide) into the product stream.

However, it is important to note that the present invention removes carbon dioxide only from the gas stream used as fuel for the local gas engine which drives the compressor. It is not the function of the present invention to remove carbon dioxide from the output stream flowing in conduit 6. Instead, it is understood that the stream exiting at conduit 6 will be treated later, at some other facility, to remove carbon dioxide and other undesirable materials. It is necessary to remove carbon dioxide, eventually, for various reasons, including those stated above. Moreover, if the natural gas contains a large proportion of carbon dioxide, it may be unsaleable, or saleable only at a discounted price.

The system of the present invention can be modified in various ways. The invention is not limited to the specific type of membranes used, as long as they are capable of selecting for water vapor, in the case of the dehydration membrane, and for carbon dioxide, in the case of the gas-separation membrane. These modifications, and others which will be apparent to those skilled in the art, should be considered within the spirit of the present invention.

What is claimed is:

1. In a system for producing natural gas, the system including a source of natural gas and means for extracting natural gas from the source, a compressor for compressing the extracted natural gas, the compressor being operated by a gas engine, and means for conveying the compressed natural gas towards a point of use,
the improvement comprising:
a conduit for withdrawing a portion of the compressed natural gas,
a dehydration membrane connected to said conduit, the dehydration membrane having an output comprising dried natural gas,
the output of the dehydration membrane being connected to a fuel line which supplies a gas engine which operates the compressor.

2. The improvement of claim 1, further comprising a gas-separation membrane, connected between the dehydration membrane and the gas engine, wherein the gas engine receives, as fuel, dried natural gas from which carbon dioxide has been removed.

3. The improvement of claim 1, wherein the dehydration membrane produces a non-permeate stream which is connected to function as a sweep gas.

4. The improvement of claim 2, wherein the gas-separation membrane produces a non-permeate stream which is connected to function as a sweep gas.

5. The improvement of claim 1, wherein the dehydration membrane produces a permeate gas which is connected to a conduit which is upstream of the gas engine.

6. The improvement of claim 2, wherein the gas-separation membrane produces a permeate gas which is connected to a conduit which is upstream of the gas engine.

7. The improvement of claim 1, further comprising means for reducing pressure of said portion of the compressed natural gas before said compressed natural gas enters the dehydration membrane.

8. A system for producing compressed natural gas, comprising:
a) means for extracting natural gas from a source,
b) a compressor for compressing the extracted natural gas, the compressor being operated by a gas engine,
c) means for conveying compressed natural gas towards a point of use,
d) means for diverting a portion of the compressed natural gas from the conveying means to a pressure-reducing means, and then to a dehydration membrane, the dehydration membrane having an output comprising dried natural gas,
e) a gas-separation membrane, the membrane having a material chosen to select between natural gas and carbon dioxide, the gas-separation membrane being connected to receive the output of the dehydration membrane, the gas-separation membrane having an output which is connected to a fuel line for the gas engine.

9. The system of claim 8, wherein the dehydration membrane produces a permeate gas which is connected to a conduit which is upstream of the gas engine.

10. The system of claim 9, wherein the gas-separation membrane produces a permeate gas which is connected to a conduit which is upstream of the gas engine.

11. In a method of making compressed natural gas, the method including extracting natural gas from a source, compressing the natural gas, and conveying the compressed natural gas towards a point of use,
the improvement comprising:
conveying a portion of the compressed natural gas into a dehydration membrane, to produce dried natural gas,
directing the dried natural gas into a gas-separation membrane, the gas-separation membrane being chosen for its selectivity relative to carbon dioxide, so as to produce an output stream from which carbon dioxide has been removed, and
directing the output stream into a fuel line of a gas engine which operates a compressor for compressing the natural gas, wherein the engine is powered by natural gas which has been dried and from which carbon dioxide has been removed.

12. The improvement of claim 11, wherein the conveying step is preceded by reducing pressure of said compressed natural gas.

13. The improvement of claim 11, wherein the dehydration membrane produces a first permeate gas, and wherein the method further comprises recycling said first permeate gas to a conduit upstream of the compressor.

14. The improvement of claim 13, wherein the gas-separation membrane produces a second permeate gas, and wherein the method further comprises recycling said second permeate gas to a conduit upstream of the compressor.

15. The improvement of claim 11, further comprising using a non-permeate stream produced by the dehydration membrane as a sweep gas.

16. The improvement of claim 15, further comprising using a non-permeate stream produced by the gas-separation membrane as a sweep gas.

17. A method of making compressed natural gas, comprising:
a) extracting natural gas from a source,
b) compressing the extracted natural gas with a compressor operated by a gas engine,
c) conveying the compressed natural gas towards a point of use,
d) diverting some of the compressed natural gas into a dehydration membrane, and also into a gas-separation membrane, wherein the gas- separation membrane is chosen for its selectivity for carbon dioxide, wherein there is produced a stream of dried natural gas from which carbon dioxide has been removed, and
e) using said stream as fuel for the gas engine.

18. The method of claim 17, wherein the diverting step includes reducing a pressure of the compressed natural gas before said gas flows into the dehydration membrane.
